(19) United States
(12) Patent Application Publication
(10) Pub. No.: US 2020/0293995 A1
(43) Pub. Date: Sep. 17, 2020

(54) CROWDSOURCING MULTI DISCIPLINARY CREATIVE WORK THROUGH A NETWORK

(71) Applicant: SHUTTERSTOCK, INC., New York, NY (US)

(72) Inventors: Nael EL SHAWWA, Toronto (CA); Kristen SAMS, Toronto (CA)

(21) Appl. No.: 16/351,411

(22) Filed: Mar. 12, 2019

(51) Int. Cl. G06Q 10/10; G06Q 10/06; G06F 9/50; G06F 16/901; G06F 16/93

(52) U.S. Cl. CPC G06Q 10/103; G06Q 10/06311; G06Q 10/0635; G06F 16/93; G06F 9/5005; G06F 16/9024; G06Q 10/06313

(57) ABSTRACT

A method for identifying a creative request from a user, and determining a resource for satisfying the creative request is provided. The method also includes adding the creative request and the resource in a project, recognizing a risk associated with an availability of the resource according to a database, and identifying a collaborator based on a match between the creative request and a quality of the collaborator. The method also includes assigning a task to the collaborator based on a map between multiple tasks in the creative request, verifying a completion of the task by the collaborator, forming a feedback loop for the project, and scoring the project based on an information collected from the feedback loop. A system and a non-transitory, computer-readable medium storing instructions to perform the above method are also provided.

### BACKGROUND

### Field

The present disclosure generally relates to editing applications for creative multimedia projects. More specifically, the present disclosure relates to editing applications that enable a project manager to allocate tasks to multiple designers to complete a graphic, design, or multi-media project, upon request by a project master.

### Description of the Related Art

Current collaboration engines are typically focused on specific applications (e.g., word editing applications, graphic editing, soundtrack editing) and lack the capability to correlate multiple disciplines with multiple collaborators having disparate creative skills and resources. Further, the approach for crowdsourcing of talent typically is localized within specific areas of expertise, geographical zones, language, and talents (e.g., music, photography, cinematography, graphic design, and the like). The lack of a unified, global talent crowdsourcing scheme results in lost opportunity for talented individuals and project masters, and less than optimal execution of the projects.

### SUMMARY

In one embodiment of the present disclosure, a computer-implemented method is described for identifying a creative request from a user, and determining a resource for satisfying the creative request. The computer-implemented method also includes adding the creative request and the resource in a project, recognizing a risk associated with an availability of the resource according to a database, and identifying a collaborator based on a match between the creative request and a quality of the collaborator. The computer-implemented method also includes assigning a task to the collaborator based on a map between multiple tasks in the creative request, verifying a completion of the task by the collaborator, forming a feedback loop for the project, and scoring the project based on an information collected from the feedback loop.

According to one embodiment, a system is described that includes one or more processors and a memory coupled to the one or more processors, the memory including instructions that, when executed by the one or more processors, cause the one or more processors to identify a creative request from a user and to determine a resource for satisfying the creative request. The one or more processors also execute instructions to include the creative request and the resource in a project, to recognize a risk associated with an availability of the resource according to a database, and to identify a collaborator based on a match between the resource and a quality of the collaborator. The one or more processors also execute instructions to assign a task to the collaborator based on a map between multiple tasks in the creative request, to verify a completion of the task by the collaborator, to form a feedback loop for the project, and to score the project based on an information collected from the feedback loop.

According to one embodiment, a non-transitory, machine-readable medium is described that includes instructions, which when executed by one or more processors, cause a computer to perform a method, including identifying a creative request from a user, determining a resource for satisfying the creative request, and including the creative request and the resource in a project. The method also includes recognizing a risk associated with an availability of the resource according to a database, identifying a collaborator based on a match between the resource and a quality of the collaborator, and assigning a task to the collaborator based on a map between multiple tasks in the creative request. The method also includes verifying a completion of the task by the collaborator, forming a feedback loop for the project, and scoring the project based on an information collected from the feedback loop.

In yet other embodiment, a system is described that includes a means for storing commands and a means for executing the commands causing the system to perform a method that includes identifying a creative request from a user, determining a resource for satisfying the creative request, and including the creative request and the resource in a project. The method also includes recognizing a risk associated with an availability of the resource according to a database, identifying a collaborator based on a match between the resource and a quality of the collaborator, and assigning a task to the collaborator based on a map between multiple tasks in the creative request. The method also includes verifying a completion of the task by the collaborator, forming a feedback loop for the project, and scoring the project based on an information collected from the feedback loop.

In one embodiment, a computer-implemented method is described for receiving, in a client device, a request from a server to collaborate in a creative project, the request comprising at least one task and a timeline for completion of the task. Then computer-implemented method also includes providing, upon receipt of the request, a request to access a document in a database hosted by the server, and a request to access a project management engine in the server, and updating, in the server, a resource item available for performing the at least one task. The computer-implemented method also includes updating, in the server, the timeline for completion of the task, and in response to an approval of the timeline for completion of the task, editing the document in the database.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture suitable for a crowdsourcing creative agency, according to some embodiments.

FIG. 2 is a block diagram illustrating an example server and client from the architecture of FIG. 1, according to certain aspects of the disclosure.

FIG. 3 illustrates a collaboration scale model including a project management engine, according to some embodiments.

FIG. 4 illustrates a portion of a database of creative collaborators in a crowdsourcing creative agency, according to some embodiments.

FIG. 5 illustrates a display of a contribution for a project in a project management engine, according to some embodiments.

FIG. 6 illustrates a graph for a creative network used by a project management engine in a crowdsourcing creative agency, according to some embodiments.

FIG. 7 is a flow chart illustrating steps in a method for managing a creative project, according to some embodiments.

FIG. 8 is a flow chart illustrating steps in a method for matching project tasks with talent resources for a crowdsourcing creative agency, according to some embodiments.

FIG. 9 is a flow chart illustrating steps in a method for accessing a crowdsourcing creative agency to collaborate on a creative project, according to some embodiments.

FIG. 10 is a block diagram illustrating an example computer system with which the client and server of FIGS. 1 and 2 and the methods of FIGS. 7-9 can be implemented.

### In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

As used herein, the term “content item” may be used, for example, in reference to a digital file that is composed of one or more media elements of different types (text, image, video, audio, and the like). A content item can be a single picture, a single video file, an audio file, or any combination of the above. The term “image identifier” as used herein may refer to a form of metadata such as a tag and a label, or a search query associated with an image for identifying the image.

The present disclosure relates to a crowdsourcing platform for matching talent with creative project specifications and timelines. Some embodiments include a technical solution to the technical problem of finding an optimal combination of talent with resources to accomplish a complex problem in a reduced time. Some embodiments combine three distinct capabilities that enable a technology to scale and crowd source creative work typically performed by creative agencies: a creative network, a Project Identification & Project Space, and an artificial intelligence (AI) based matching engine between creative collaborators (supply-side) and projects (demand-side). The creative network includes a database listing multiple creative collaborators from which embodiments as disclosed herein may select the one or more collaborators for a project. In addition, the database includes the resources available to each of the creative collaborators and is able to realistically estimate a time for completion of the project. Moreover, systems as disclosed herein are able to provide a project timeline and verify its execution in real time (e.g., as events develop). A creative project as disclosed herein may include a graphic design project, a photography project, a video project, a music project, a movie, or any combination of the above.

Some implementations provide a front-end portal that users can access remotely using a mobile device or a workstation to request, create, supervise, or collaborate with, a creative project. Embodiments as disclosed herein provide a solution to the problem arising in the realm of computer technology of providing a user-friendly platform for a collaborative environment of highly skilled individuals to provide a high-end deliverable. The collaborators may access the platform from any location, and the tools for their performance are provided within the platform regardless of the specific client device used by the collaborator for access.

The subject system provides several advantages, including a feature for breaking a project into multiple tasks and finding the most qualified individuals to execute each task, separately or in coordination with one another. The proposed solution further provides improvements to the functioning of the computer itself because it reduces storage requirements and processing capabilities on individual client devices.

### Example System Architecture

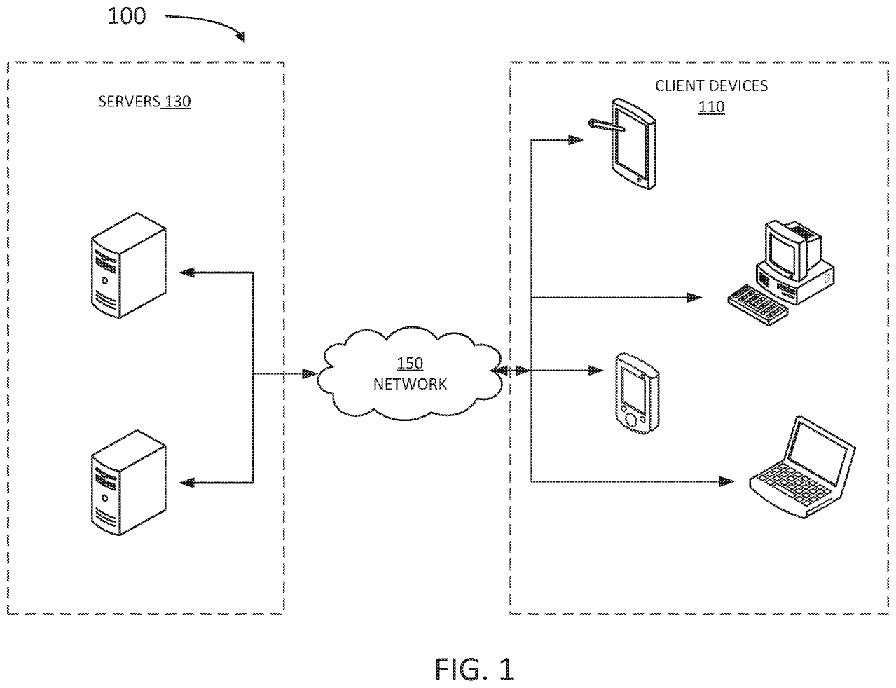

FIG. 1 illustrates an example architecture 100 suitable for a crowdsourcing creative agency, according to some embodiments. Architecture 100 includes servers 130 communicatively coupled with client devices 110 over a network 150. One of the many servers 130 is configured to host a memory including instructions which, when executed by a processor, cause the server 130 to perform at least some of the steps in methods as disclosed herein. In some embodiments, the processor is configured to manage a creative project upon request by the user of one of client devices 110. The creative project may include a multimedia advertising campaign, a movie or movie clip, a website launch, a musical composition, artistic development, or any other graphic design project. Accordingly, the processor may include a project management engine with a document editing tool, configured to create and modify documents in the creative project. For purposes of load balancing, multiple servers 130 can host memories including instructions to one or more processors, and multiple servers 130 can host a history log and the second image database. Moreover, the creative project may be a collaborative project involving multiple users with client devices 110 accessing one or more servers 130 where one or more project documents are stored. In that regard, the user of client device 110 may be a project master requesting server 130 to execute a creative project. In some embodiments, the user of client device 110 may be one or more collaborators assigned with at least one of multiple tasks in the creative project by server 130. Moreover, in some embodiments, multiple users of client devices 110 may include the project master and at least one collaborator assigned with a task in the creative project. Accordingly, client devices 110 may communicate with each other via network 150 and through access to server 130 and resources located therein.

Servers 130 may include any device having an appropriate processor, memory, and communications capability for hosting the project management engine including multiple tools associated with it. The project management engine may be accessible by various clients 110 over the network 150. Clients 110 can be, for example, desktop computers, mobile computers, tablet computers (e.g., including e-book readers), mobile devices (e.g., a smartphone or PDA), or any other devices having appropriate processor, memory, and communications capabilities for accessing the project management engine on one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

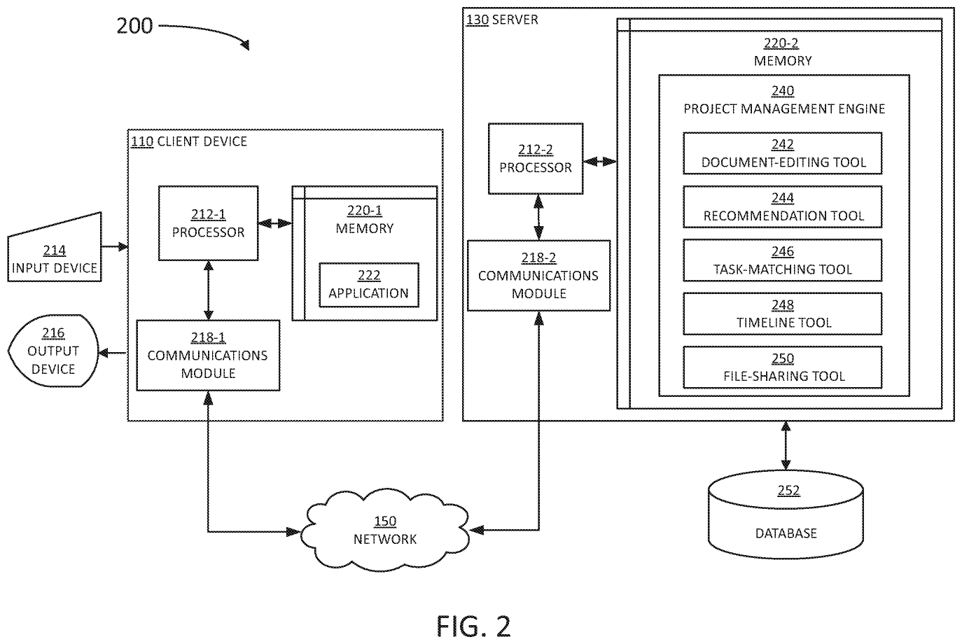

FIG. 2 is a block diagram illustrating an example server 130 and client device 110 from the architecture of FIG. 1, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. A user may interact with client device 110 via an input device 214 and an output device 216. Input device 214 may include a mouse, a keyboard, a pointer, a touchscreen, a microphone, and the like. Output device 216 may be a screen display, a touchscreen, a speaker, and the like. Client device 110 may include a memory 220-1 and a processor 212-1. Memory 220-1 may include an application 222, configured to run in client device 110. Application 222 may be downloaded by the user from server 130, and may be hosted by server 130.

Server 130 includes a memory 220-2, a processor 212-2, and communications module 218-2. Hereinafter, processors 212-1 and 212-2, and memories 220-1 and 220-2 will be collectively referred to, respectively, as “processors 212” and “memories 220.” Processors 212 are configured to execute instructions stored in memories 220. In some embodiments, memory 220-2 includes a project management engine 240. Project management engine 240 may share or provide features and resources to application 222, including multiple tools associated with managing a creative project. The user may access project management engine 240 through application 222 or a web browser installed in a memory 220-1 of client device 110. Accordingly, application 222 may be installed by server 130 and perform scripts and other routines provided by server 130 through any one of multiple tools. Execution of application 222 may be controlled by processor 212-1.

In that regard, project management engine 240 may include a document-editing too1242, a recommendation tool 244, a task-matching too1246, a timeline tool 248, and a file-sharing too1250. Document-editing too1242 enables a collaborator to access and edit documents (e.g., through application 222). For example, in some embodiments, the user may upload a document to server 130 and use document-editing tool 242 to modify, update, or combine the document with other documents provided by a second, third, or any number of other users collaborating in the creative project. In some embodiments, document-editing tool enables the curation of one or more assets delivered to the project including photos, videos, and music (e.g., through network 150 or database 252).

Recommendation tool 244 provides the ability to get recommendations for new creative collaborators to be invited to the project.

Task-matching too1246 is configured to match a resource for the creative project to a specific task for the project. Further, task-matching too1246 may be configured to assign the specific task to a collaborator based on the user availability and resources. Timeline tool 248 is configured to associate a timeline with the creative project. For example, timeline tool 248 may associate the different tasks in the creative project to an allotted time for completion. Depending on the interdependence of the tasks, timeline tool 248 may create overlapping tasks, simultaneous, quasi-simultaneous, or parallel tasks, assigned to different collaborators. File-sharing too1250 may be configured to allow different collaborators and the project master to exchange files and share editing capabilities in the files. Further, file-sharing too1250 may provide communication and chat ability between different collaborators accessing a document, or associated with a task in the project (e.g., chat, text messaging, e-mail, videoconferencing, and the like). Accordingly, file-sharing too1250 may interact with communications modules 218 so that users may relay to one another the status of deliverables for different tasks in the project.

In some embodiments, at least one of document-editing too1242, recommendation tool 244, task-matching too1246, timeline tool 248, and file-sharing too1250 may include a neural network algorithm including multiple layers having nodes and coefficients associated to each node. The coefficients are determined based on a training set, wherein the gradients of the coefficients are weighted according to a desired outcome. Accordingly, in some embodiments, project management engine 240 is configured to access a database 252 to retrieve documents that any one of the collaborators may desire for the creative project, to store any one of the documents updated by the collaborators, or to access information associated to the collaborators. In some embodiments, recommendation tool 244 may access database 252 to retrieve information regarding multiple subscribers who may be candidate collaborators in the creative design project. In some embodiments, project management engine 240, the tools contained therein, and at least part of database 252 may be hosted in a different server that is accessible by server 130.

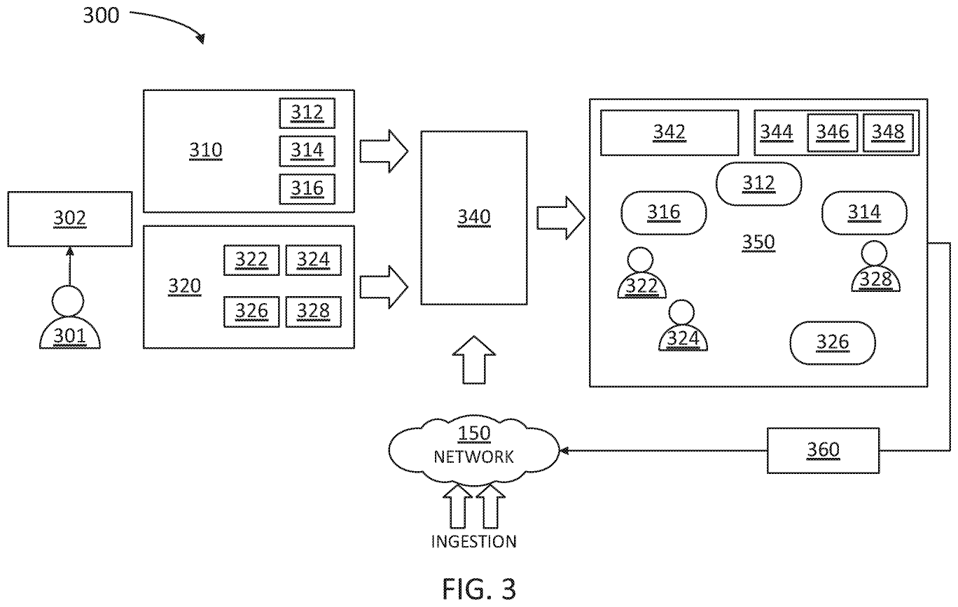

FIG. 3 illustrates a collaboration scale model 300 including a project management engine 340, according to some embodiments. Model 300 is a box diagram indicating hardware and procedures involved in the process of planning for, and executing, a creative project. A project master 301 accesses a creative wizard, which can be a server hosting project management engine 340, to request planning and execution of a creative project 302. Project master 301 may be an individual user or brand, interested in an advertising campaign, a promotional video, a musical production, or even a movie production. In that regard, project 302 may be any artistic, commercial, or generally intellectual endeavor, for entertainment, profit, educational, scientific, artistic purposes, or any combination of the above. Project management engine 340 may classify project 302 according to different types or categories, including, but not limited to, the following: Lifestyle, Product, Nature & Landscapes, Food & Drink, Portraits & People, Sports, Beauty, Automotive, Families, Pets, Urban, Creative Concepts, Recipes, Architecture, Real Estate, Editorial, Events, On-location, and the like.

In some embodiments, project management engine 340 guides project master 301 through various steps, identifying resources for project 302. Accordingly, project management engine 340 may identify available resources 310, and searchable resources 320. In some instances, project management engine 340 establishes one or more deliverables for project 302, which can be associated to tasks, performed by one or more collaborators 322, a project manager 324, and a producer 328. Collaborators 322 may include individuals having talents and assets that are registered with project management engine 340. For example, collaborator 322 may be a photographer having a specific camera, and certain specialized skills or abilities, such as access to specific locations 314 and models (e.g., people or places such as homes, cars, real estate, and the like). In some embodiments, each of the tasks may include at least one deliverable 312 (e.g., a ‘short-film,’ a poster, a jingle, a website) as well as a talent 316 and a location 314. Collaborator 322 may include an internal collaborator, e.g., a user from the organization of project master 301, such as an art director or a manager. In some embodiments, collaborator 322 may include one or more external collaborators such as other creative collaborators in the network that would be responsible for completing one or more tasks in project 302. In some embodiments, project manager 324, producer 328, and project master 301 may be one and the same person, or different tasks associated with one, two, or more users having the appropriate credentials with project management engine 340. Project manager 324 and producer 328 may share the ability to invite more internal or external collaborators for different tasks in project 302.

Project management engine 340 provides a project space 350 including tools 342 and add-on's 344. Tools 342 may include project management communication tools, file sharing tools, and other personalization tools. In some embodiments, tools 342 may include a document-editing tool configured to manipulate and edit documents and a recommendation tool configured to select a collaborator 322 that matches the skills desired for a specific task (e.g., document-editing too1242 and recommendation tool 244). Tools 342 may also include a task-matching tool to identify the tasks and available resources 310 or searchable resources 320, a timeline tool to create a time schedule for performance of each of the tasks, and a file-sharing tool to enable multiple collaborators 322 to share documents and deliverables with each other, with project manager 324, or with producer 328 (e.g., task-matching too1246, timeline tool 248, and file-sharing too1250). In some embodiments, a file-sharing tool provides the ability to share supporting documentation required for the project including files such as storyboards, mock ups, or PDF documents. Add-on's 344 may include marketplace features 346 and additional resources 348. Project space 350 handles available resources 310 and searchable resources 320 in view of the project objectives, timeliness, and budget.

Project space 350 may include several features, such as task and project management. A task may include a creative process assigned to collaborator 322 for completion. Examples of tasks may include, without limitation: capturing moments of a family setting up a nursery at home and editing photos based on feedback from a brand's stakeholders. Project 350 also handles role based permissions (e.g., through the file sharing tool), so that collaborator 322, project manager 324, producer 328, and project master 301 may access different documents with different privileges. Project space 350 also enables management of visibility and actions allowed between different parties (e.g., blocking internal communication between different collaborators 322 from project manager 324 and producer 328). Project space 350 also provides a project overview to project manager 324, producer 328, or project master 301. The project overview may include an outline of the creative requirements and tasks required for a project and a status update across tasks and who is performing the work.

Project space 350 also provides the ability for collaborators 322 to comment on various assets created and various notifications. For example, project space 350 provides notifications for collaborators 322 on availability for new work and when they have been matched or invited to join project space 350. In some embodiments, project space 350 provides notifications for payments (e.g., to collaborators 322) and the ability to set up payment profiles to receive and send payments for creative work performed. In some embodiments, project space 350 also provides (e.g., to project manager 324, producer 328, or project master 301) the ability to approve, reject, or qualify project collaborators 322 (including assets and models), or other assets such as concepts, ideas, and deliverables 312.

In addition to splitting project 302 into tasks and allocating resources, project management engine 340 allocates a post-production stage 326 to complete the project, and manage a feedback 360 through network 150. Feedback 360 may include feedback from collaborators 322, from project manager 324, from producer 328, from project master 301, or any combination of the above. Moreover, feedback 360 may be provided from other users, the general public, or a focus group selected from the public. More generally, in embodiments consistent with the present disclosure, model 300 relies on network 150 to retrieve profiles, skills, availability, and cost values for talent, equipment, and other resources desirable for the project.

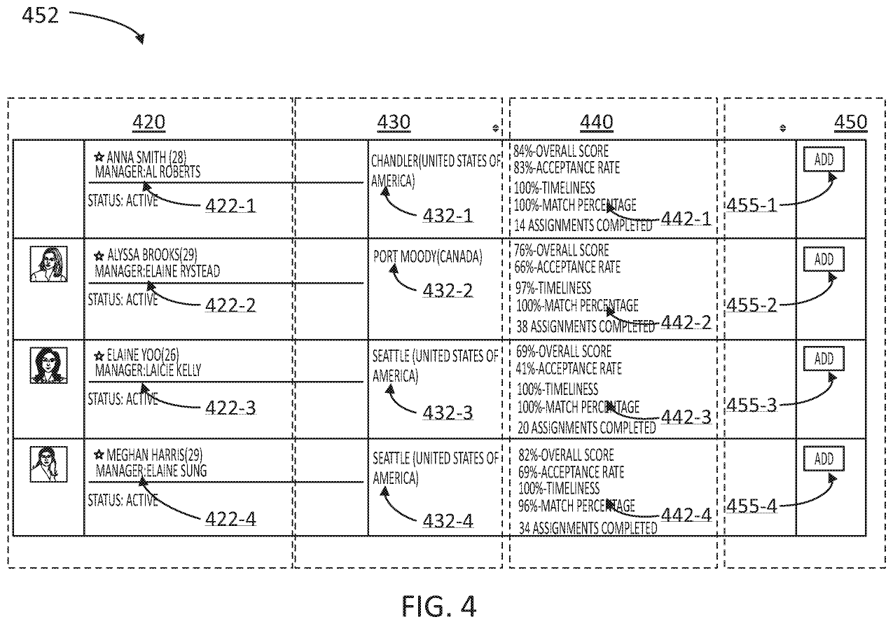

FIG. 4 illustrates a portion of a database 452 of creative collaborators 422-1, 422-2, 422-3, and 422-4 (hereinafter, collectively referred to as “collaborators 422”) in a crowdsourcing creative agency, according to some embodiments. In some embodiments, the crowdsourcing creative agency is running on a project management engine installed on a server coupled with database 452 (e.g., project management engine 240, server 130, and database 252). In some embodiments, database 452 is accessible to a project master that has registered with a server running the project management engine. Database 452 includes a network of creative talent available to execute on creative projects for online and offline marketing campaigns. Collaborators 422 may include photographers, animators, editors, directors, producers, writers, and musicians. The talent would be tagged and categorized based on their skills and experience to feed into a task-matching tool(e.g., task-matching too1246).

Database 452 includes a names column 420, a locations column 430, and a scorecard column 440, including information relative to each of collaborators 422. Locations column 430 includes locations 432-1, 432-2, 432-3, and 432-4 (hereinafter, collectively referred to as “locations 432”) for each of collaborators 422. Scorecard column 440 includes scorecards 442-1, 442-2, 442-3, and 442-4 (hereinafter, collectively referred to as “scorecards 442”) for each of collaborators 422. Scorecards 442 may include information such as an acceptance rate, a timeliness rate, a match percentage, a total number of assignments, and an overall score, for each of collaborators 422. Information in scorecard column 440 is useful to assign one or more tasks in the creative process to either one of collaborators 422. To do this, an assignment column 450 includes assignment tabs 455-1, 455-2, 455-3, and 455-4 (hereinafter, collectively referred to as “assignment tabs 452”), with which the project master may decide to assign a task for each of collaborators 422.

In some embodiments, names column 420 may include more detailed information for each of collaborators 422, such as: Age and assets. The assets may include, access to venues/sites or the list and address of locations they have access to (a beach house, a high-end condo, a cottage, and the like). The assets for each collaborator 422 in names column 420 may also include access to models: list of models, their names, ages, gender, background, physical locations, and sample photos for each. Depending on the talent types, in some embodiments, database 452 may include additional attributes of collaborators 422. Thus, a task-matching tool may be able to identify and assess more accurately the level of capability for each collaborator 422. Collaborators 422 may encompass a wide variety of talents, professions, and artists.

For example, in some embodiments, collaborators 422 may include photographers, videographers, editors and animators, and game developers. Accordingly, in some embodiments, database 452 may include asset values such as camera model and other equipment they possess (lens, lighting for models or products, and the like). Also, database 452 may include, for each collaborator 422 values in scorecard column 440 such as aesthetics scores for the portfolio of collaborator 422, categorized by the type of photography (Editorial vs. Sports vs. Lifestyle, and the like). Database 452 may further include information regarding other supporting skill sets and their ratings such as photo editing, staging scenes, wardrobe, makeup, and the like, for each collaborator 422.

In some embodiments, collaborators 422 may include Producers, Directors, and Writers (e.g., for the motion pictures industry). Accordingly, database 452 may also include roles related to storytelling and ideating scenarios, for each of collaborators 422. Further, scorecard column 440 may include measurements of the creative talent for engaging stories and their marketing impact. In some embodiments, collaborators 422 may be scored based on their ability to ideate across different categories such as Short Films, Photo narratives, Editorial, and Commercials and ads (for products and services).

In some embodiments, collaborators 422 may include Musicians, Sound engineers, Voice-over, and Composers. Accordingly, database 452 may include collaborators who can create their own music, sound effects, and edit these sounds and align them with footage that is being created (e.g., as part of a project). Accordingly, some of the attributes listed in database 452 for collaborators 422 may include: Style of music they have worked on/created, executed, or danced (techno, electronic, pop, classical, Jazz, and the like), or mood, such as “Action,” “Dark,” “Uplifting,” “Melancholy,” and the like. Further, database 452 may include in the assets for each collaborator 422, an instrument (type, class) and scorecard column 440 may grade collaborator 422 for each instrument.

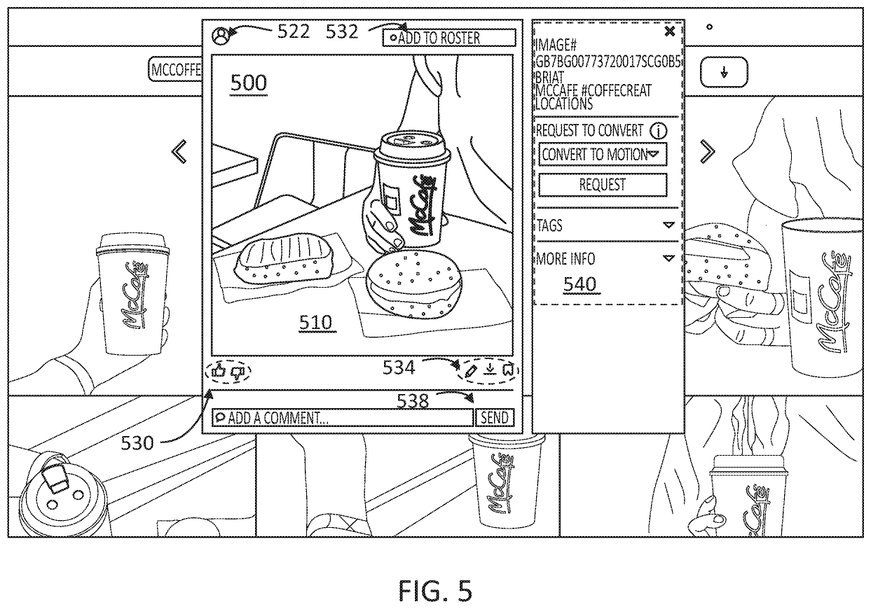

FIG. 5 illustrates a display 500 of a contribution 510 for a project in a project management engine (e.g., project management engine 240), according to some embodiments. Contribution 500 may be accessed by the collaborator who created the contribution, the project master, or any other collaborator in the project, based on privileges in a setting configuration for the project according to the project management engine. A user 522 may access contribution 510 through an application in a client device (e.g., application 222 in client device 110). User 522 may be a project collaborator (e.g., collaborators 322 and 422), or a project master. Display 500 includes a feedback tool 530 (e.g., thumbs “up” or “down”) with which user 522 may evaluate contribution 530. Other tools 534 in display 500 may include a comments tool (pencil icon), with which user 522 may provide written or textual comments on contribution 510. Tools 534 may include a download tool with which user 522 may download contribution 510 to a local memory (e.g., memory 220-1), or a flag tool. Display 500 may also include a “send” tab 538 so that user 522 may send contribution 510 to another user, another collaborator, or the project master, and a tab 532 with which a project master may add the collaborator that created contribution 510 to a project roster. An editing field 540 may allow user 522 to perform further modifications to contribution 510. For example, editing field 540 may include, in some embodiments, a “convert to motion” tab wherein an image contribution (or a group of images) may be converted into a short video clip (including music or soundtrack). In that regard, contribution 510 may be a graphic file, an image, a video, an audio file, a music video, and the like.

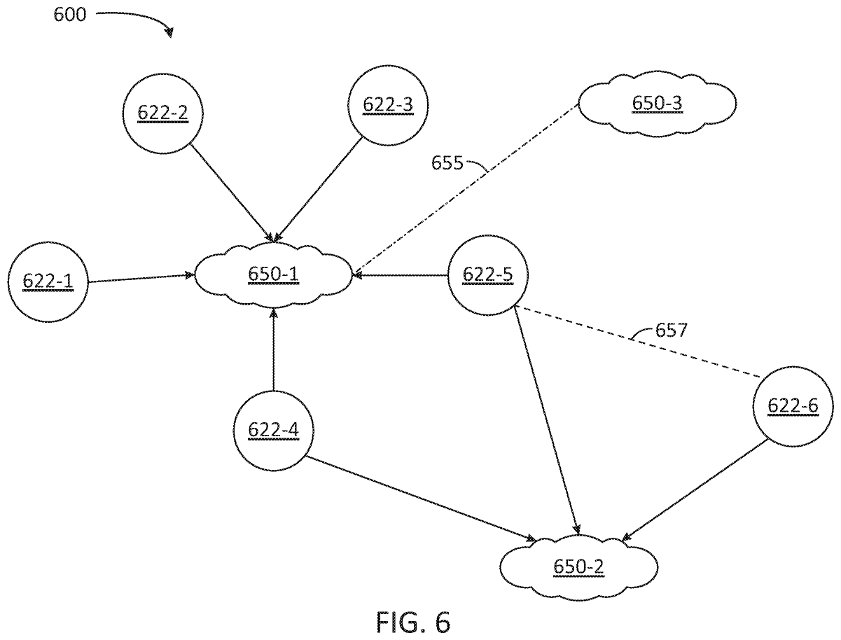

FIG. 6 illustrates a graph 600 for a creative network used by a project management engine in a crowdsourcing creative agency, according to some embodiments. Graph 600 may be accessible to a user of a project management engine hosted by a server, the user accessing graph 600 via an application in a client device, over a network (e.g., client device 110, server 130, application 222, and project management engine 240). The user may be, for example, a project master looking for matches to potential collaborators for a new project, or a server administrator diagnosing the status of a crowdsourcing creative agency hosted by the server.

Projects 650-1, 650-2, and 650-3 (hereinafter, collectively referred to as “projects 650”) may be past, present, or future projects in which the crowdsourcing creative agency has been involved. Collaborators 622-1, 622-2, 622-3, 622-4, 622-5, and 622-6 (hereinafter, collectively referred to as “collaborators 622”) are linked to projects 650 according to their participation in each of them.

In some embodiments, projects 650 may be performed simultaneously, or overlapping in time. In some embodiments, one or more of projects 650 may have been completed, or even cancelled, and one or more of projects 650 may not have been started. Accordingly, graph 600 may not have a timeline indicator. In yet other embodiments, graph 600 may actually include a timeline indicator, either by a color scale (e.g., a grayscale from black to white, white indicating most recent), or by a position in the frame (e.g., left to right, right being the most recent, or bottom to top, top being most recent). A link 655 may indicate that project 650-3 is a development, or continuation, of project 650-1. A link 657 may indicate that collaborators 622-5 and 622-6 interacted for at least one contribution during their participation in project 650-2.

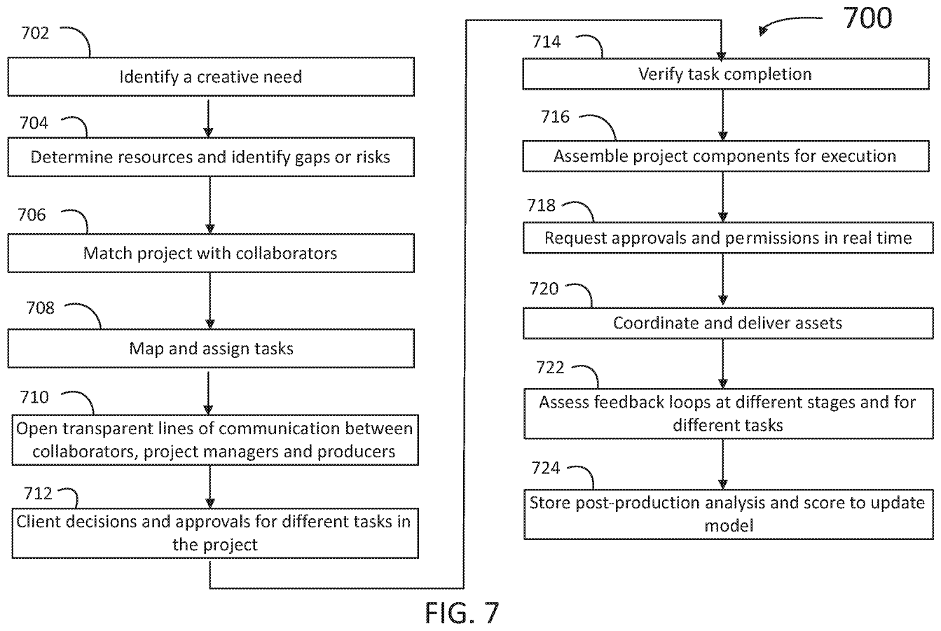

FIG. 7 is a flow chart illustrating steps in a method 700 for managing a creative project, according to some embodiments. At least one or more of the steps in method 700 may be performed by a computer system in a client device or a server, the client device and the server being communicatively coupled through a network via a communications module (e.g., client device 110, server 130, network 150, and communications modules 218). The computer system may include a memory storing instructions which, executed by a processor, perform at least partially one or more of the steps in method 700 (e.g., processors 212 and memories 220). In some embodiments, one or more steps in method 700 is at least partially executed by an application installed in the client device and hosted by a project management engine in the server (e.g., application 222 and project management engine 240). Further, in some embodiments, one or more of the steps in method 700 may be performed by a document editing tool, a recommendation tool, a task matching tool, a timeline tool, and a file sharing tool, in the project management engine (e.g., document-editing too1242, recommendation tool 244, task-matching too1246, timeline tool 248, and file-sharing too1250). Further, in some embodiments, data and information used in, or generated by, at least one of the steps in method 700 may be stored in a database communicatively coupled to, and hosted by, the server (e.g., database 252).

Methods consistent with the present disclosure may include at least one or more of the steps in method 700 performed in a different order. For example, in some embodiments, steps in method 700 may be performed simultaneously, quasi-simultaneously, or overlapping in time.

Step 702 includes identifying a creative need. In some embodiments, step 702 may include receiving a request for a project from a user, such as a movie producer, a play producer, or a brand manufacturer that desires to create a television commercial.

Step 704 includes determining resources and identifying gaps or risks. In some embodiments, step 702 may include assessing what are the desirable assets to accomplish the goals of the creative project and determine whether a talent pool in the network is able to address each of the desirable assets. If this is not the case, step 704 may identify the degree to which the talent pool satisfies the desirable assets.

Step 706 includes matching the project with collaborators. In some embodiments, step 706 may include finding actors for a movie, or finding set designers for a television commercial.

Step 708 includes mapping and assigning tasks. Accordingly, in some embodiments step 708 may include selecting a cast of actors for a movie, where certain collaborators are assigned to certain roles or characters in the movie, or play.

Step 710 includes opening transparent lines of communication between collaborators, project managers, and producers. For example, step 710 may include providing chat rooms and other messaging channels between different actors in the movie or play, or between the actors and the director. In some embodiments step 710 may include blocking one of the collaborators from certain communications, such as blocking the movie producer from the communications between the actors, or blocking the actors from the communications between the director and the movie producer.

Step 712 includes retrieving client decisions and approvals for different tasks in the project.

Step 714 includes verifying task completion.

Step 716 includes assembling project components for execution. In some embodiments, step 716 may include editing one or more scenes in the movie.

Step 718 includes requesting approvals and permissions in real time. In some embodiments, step 716 may include requesting approval of the producer or the director for deleting, removing, or editing certain scenes in the movie.

Step 720 includes coordinating and delivering assets. In some embodiments, step 720 may include determining movie theaters or online venues for the movie release.

Step 722 includes assessing feedback loops at different stages and for different tasks. In some embodiments, step 722 may include selecting focus groups of consumers or movie goers, or online subscriber, and providing at least portions of the movie to the focus group, for feedback.

Step 724 includes storing a post-production analysis and score, to update the model for project management. In some embodiments, step 724 may include receiving critical reviews for the movie from different journal and entertainment analysts. In some embodiments step 724 includes evaluating box office revenue or online downloads of the movie, after release.

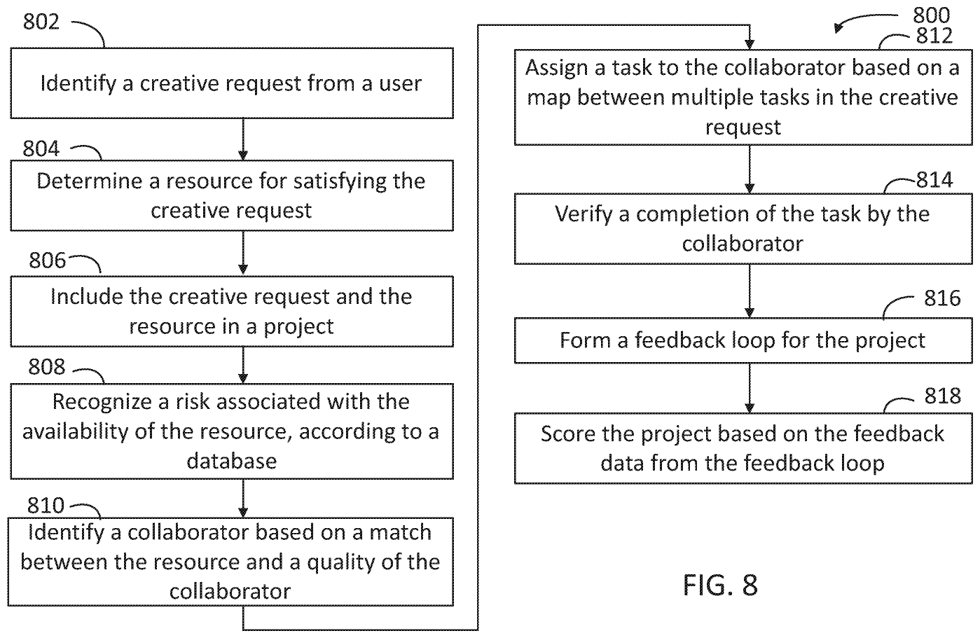

FIG. 8 is a flow chart illustrating steps in a method 800 for matching project tasks with talent resources for a crowdsourcing creative agency, according to some embodiments. At least one or more of the steps in method 800 may be performed by a computer system in a client device or a server, the client device and the server being communicatively coupled through a network via a communications module (e.g., client device 110, server 130, network 150, and communications modules 218). The computer system may include a memory storing instructions which, executed by a processor, perform at least partially one or more of the steps in method 800 (e.g., processors 212 and memories 220). In some embodiments, one or more steps in method 800 is at least partially executed by an application installed in the client device and hosted by a project management engine in the server (e.g., application 222 and project management engine 240). Further, in some embodiments, one or more of the steps in method 800 may be performed by a document editing tool, a recommendation tool, a task matching tool, a timeline tool, and a file sharing tool, in the project management engine (e.g., document-editing too1242, recommendation tool 244, task-matching too1246, timeline tool 248, and file-sharing too1250). Further, in some embodiments, data and information used in, or generated by, at least one of the steps in method 800 may be stored in a database communicatively coupled to, and hosted by, the server (e.g., database 252).

Methods consistent with the present disclosure may include at least one or more of the steps in method 800 performed in a different order. For example, in some embodiments, steps in method 800 may be performed simultaneously, quasi-simultaneously, or overlapping in time.

Step 802 includes identifying a creative request from a user. In some embodiments, step 802 includes classifying the creative request in one of multiple classes according to the database. In some embodiments, step 802 includes evaluating a recommendation for the collaborator. In some embodiments, step 802 includes matching a collaborator resource to the creative request.

Step 804 includes determining a resource for satisfying the creative request.

Step 806 includes adding the creative request and the resource in a project.

Step 808 includes recognizing a risk associated with an availability of the resource, according to a database.

Step 810 includes identifying a collaborator based on a match between the resource or the creative request and a quality of the collaborator.

Step 812 includes assigning a task to the collaborator based on a map between multiple tasks in the creative request. In some embodiments, step 812 includes opening a transparent line of communication between the collaborator and the user. In some embodiments, step 812 includes determining a relative distance between the collaborator and the creative request in a graph from the database. In some embodiments, step 812 includes allowing the collaborator to access a document handled by a project management engine, and to edit the document using a document-editing tool in the project management engine. In some embodiments, step 812 includes requesting approval of the collaborator from the user, based on a recommendation for the collaborator.

Step 814 includes verifying a completion of the task by the collaborator.

Step 816 includes forming a feedback loop for the project.

Step 818 includes scoring the project based on an information collected from the feedback loop. In some embodiments, step 818 includes allowing document sharing between the collaborator and a second collaborator for the project, based on a security protocol. In some embodiments, step 818 includes updating a database based on the scoring of the project.

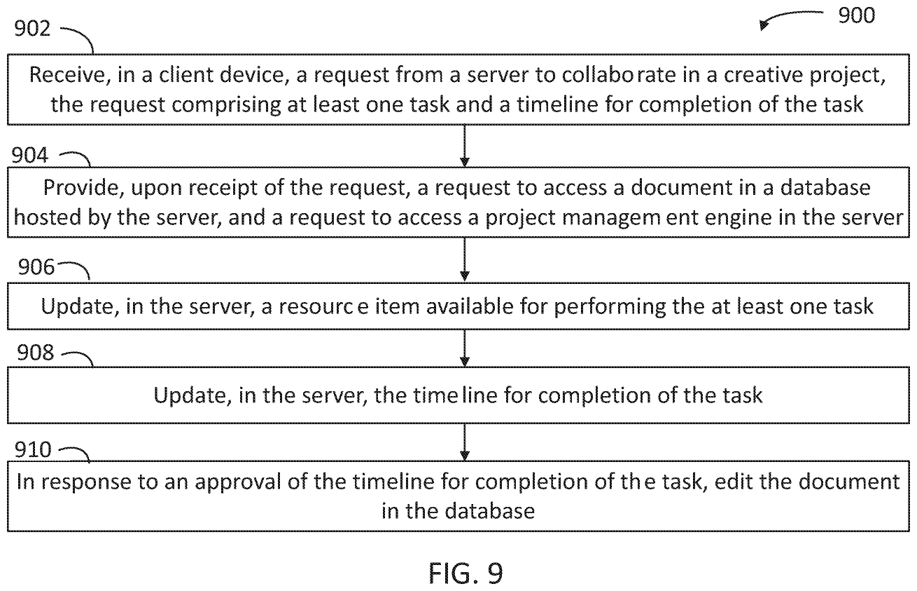

FIG. 9 is a flow chart illustrating steps in a method 900 for accessing a crowdsourcing creative agency to collaborate on a creative project, according to some embodiments. At least one or more of the steps in method 900 may be performed by a computer system in a client device or a server, the client device and the server being communicatively coupled through a network via a communications module (e.g., client device 110, server 130, network 150, and communications modules 218). The computer system may include a memory storing instructions which, executed by a processor, perform at least partially one or more of the steps in method 900 (e.g., processors 212 and memories 220). In some embodiments, one or more steps in method 900 is at least partially executed by an application installed in the client device and hosted by a project management engine in the server (e.g., application 222 and project management engine 240). Further, in some embodiments, one or more of the steps in method 900 may be performed by a document editing tool, a recommendation tool, a task matching tool, a timeline tool, and a file sharing tool, in the project management engine (e.g., document-editing too1242, recommendation tool 244, task-matching too1246, timeline tool 248, and file-sharing too1250). Further, in some embodiments, data and information used in, or generated by, at least one of the steps in method 900 may be stored in a database communicatively coupled to, and hosted by, the server (e.g., database 252).

Methods consistent with the present disclosure may include at least one or more of the steps in method 900 performed in a different order. For example, in some embodiments, steps in method 900 may be performed simultaneously, quasi-simultaneously, or overlapping in time.

Step 902 includes receiving, in a client device, a request from a server to collaborate in a creative project, the request comprising at least one task and a timeline for completion of the task.

Step 904 includes providing, upon receipt of the request, a request to access a document in a database hosted by the server, and a request to access a project management engine in the server.

Step 906 includes updating, in the server, a resource item available for performing the at least one task.

Step 908 includes updating, in the server, the timeline for completion of the task.

In some embodiments, the resource item is a hardware device, and step 908 includes configuring the hardware device according to a specification request from the server.

Step 910 includes, in response to an approval of the timeline for completion of the task, editing the document in the database. In some embodiments, step 910 includes uploading the document into the database and modifying the document using a document-editing tool in the project management engine in the server. In some embodiments, step 910 includes sharing the document with a collaborator in the creative project.

### Hardware Overview

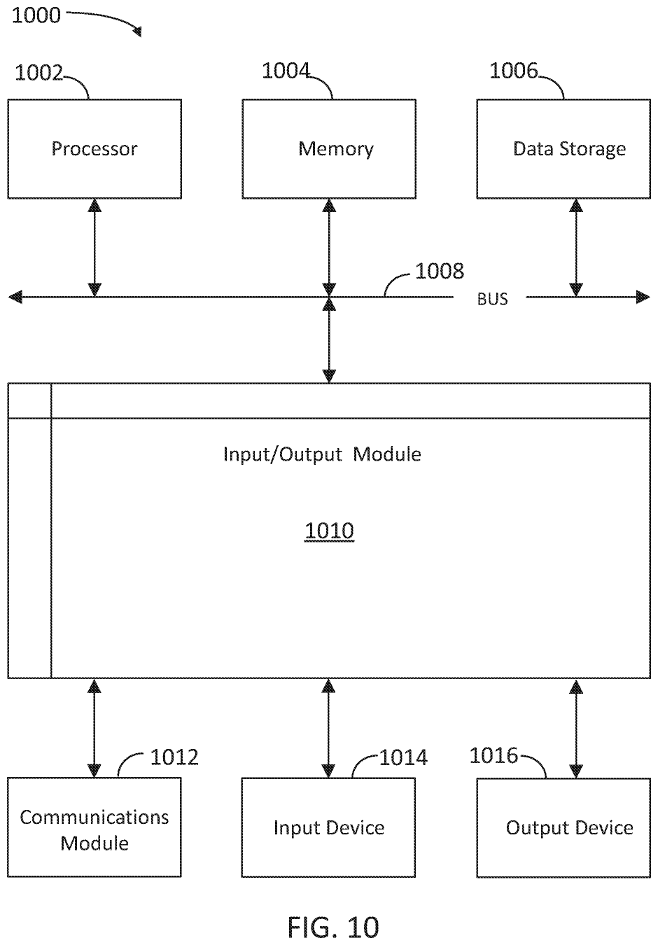

FIG. 10 is a block diagram illustrating an exemplary computer system 1000 with which the client and server of FIGS. 1 and 2, and the methods of FIGS. 7, 8, and 9 can be implemented. In certain aspects, the computer system 1000 may be implemented using hardware or a combination of software and hardware, either in a dedicated server, or integrated into another entity, or distributed across multiple entities.

Computer system 1000 (e.g., client 110 and server 130) includes a bus 1008 or other communication mechanism for communicating information, and a processor 1002 (e.g., processors 212) coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1000 can include, in addition to hardware, code that creates an execution environment for the computer program in question, e.g., code that constitutes processor firmware, a protocol stack, a database management system, an operating system, or a combination of one or more of them stored in an included memory 1004 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, e.g., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1000 further includes a data storage device 1006 such as a magnetic disk or optical disk, coupled to bus 1008 for storing information and instructions. Computer system 1000 may be coupled via input/output module 1010 to various devices. Input/output module 1010 can be any input/output module. Exemplary input/output modules 1010 include data ports such as USB ports. The input/output module 1010 is configured to connect to a communications module 1012. Exemplary communications modules 1012 (e.g., communications modules 218) include networking interface cards, such as Ethernet cards and modems. In certain aspects, input/output module 1010 is configured to connect to a plurality of devices, such as an input device 1014 (e.g., input device 214) and/or an output device 1016 (e.g., output device 216). Exemplary input devices 1014 include a keyboard and a pointing device, e.g., a mouse or a trackball, by which a user can provide input to the computer system 1000. Other kinds of input devices 1014 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1016 include display devices, such as an LCD (liquid crystal display) monitor, for displaying information to the user.

According to one aspect of the present disclosure, the client 110 and server 130 can be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in main memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication tool (e.g., network 150) can include, for example, any one or more of a LAN, a WAN, the Internet, and the like. Further, the communication tool can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1000 can include clients and servers. A client and server are generally remote from each other and typically interact through a communication network. The relationship of client and server arises by virtue of computer programs running on the respective computers and having a client-server relationship to each other. Computer system 1000 can be, for example, and without limitation, a desktop computer, laptop computer, or tablet computer. Computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires forming bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
identifying a creative request from a user;
determining a resource for satisfying the creative request;
including the creative request and the resource in a project;
recognizing a risk associated with an availability of the resource according to a database;
identifying a collaborator based on a match between the creative request and a quality of the collaborator;
assigning a task to the collaborator based on a map between multiple tasks in the creative request;
verifying a completion of the task by the collaborator;
forming a feedback loop for the project; and
scoring the project based on an information collected from the feedback loop.

2. The computer-implemented method of claim 1, wherein identifying a creative request from the user comprises classifying the creative request in one of multiple classes according to the database.

3. The computer-implemented method of claim 1, wherein identifying a collaborator comprises evaluating a recommendation for the collaborator.

4. The computer-implemented method of claim 1, wherein identifying a collaborator comprises matching a collaborator resource to the creative request.

5. The computer-implemented method of claim 1, wherein assigning a task to the collaborator comprises opening a transparent line of communication between the collaborator and the user.

6. The computer-implemented method of claim 1, wherein assigning a task to the collaborator comprises determining a relative distance between the collaborator and the creative request in a graph from the database.

7. The computer-implemented method of claim 1, wherein assigning a task to the collaborator comprises allowing the collaborator to access a document handled by a project management engine, and to edit the document using a document-editing tool in the project management engine.

8. The computer-implemented method of claim 1, wherein assigning a task to the collaborator comprises requesting approval of the collaborator from the user, based on a recommendation for the collaborator.

9. The computer-implemented method of claim 1, further comprising updating a database based on the scoring the project.

10. The computer-implemented method of claim 1, further comprising allowing a document sharing between the collaborator and a second collaborator for the project, based on a security protocol.

11. A system, comprising:
a memory storing instructions; and
one or more processors configured to execute the instructions and cause the system to:
identify a creative request from a user;
determine a resource for satisfying the creative request;
include the creative request and the resource in a project;
recognize a risk associated with an availability of the resource according to a database;
identify a collaborator based on a match between the resource and a quality of the collaborator;
assign a task to the collaborator based on a map between multiple tasks in the creative request;
verify a completion of the task by the collaborator;
form a feedback loop for the project; and
score the project based on an information collected from the feedback loop.

12. The system of claim 11, wherein to identify a creative request from the user the one or more processors further execute instructions to classify the creative request in one of multiple classes according to the database.

13. The system of claim 11, wherein to identify a collaborator the one or more processors execute instructions to evaluate a recommendation for the collaborator.

14. The system of claim 11, wherein to identify a collaborator the one or more processors execute instructions to match a collaborator resource to the creative request.

15. The system of claim 11, wherein to assign a task to the collaborator the one or more processors execute instructions to open a transparent line of communication between the collaborator and the user.

16. The system of claim 11, wherein to assign a task to the collaborator the one or more processors execute instructions to determine a relative distance between the collaborator and the creative request in a graph from the database.

17. A computer-implemented method, comprising:
receiving, in a client device, a request from a server to collaborate in a creative project, the request comprising at least one task and a timeline for completion of the task;
providing, upon receipt of the request, a request to access a document in a database hosted by the server, and a request to access a project management engine in the server;
updating, in the server, a resource item available for performing the at least one task;
updating, in the server, the timeline for completion of the task; and
in response to an approval of the timeline for completion of the task, editing the document in the database.

18. The computer-implemented method of claim 17, wherein the resource item is a hardware device, and updating the resource item further comprises configuring the hardware device according to a specification request from the server.

19. The computer-implemented method of claim 17, wherein editing the document in the database comprises uploading the document into the database and modifying the document using a document-editing tool in the project management engine in the server.

20. The computer-implemented method of claim 17, wherein editing the document in the database comprises sharing the document with a collaborator in the creative project.
